(19) United States
(12) Patent Application Publication
(10) Pub. No.: US 2026/0252568 A1
(43) Pub. Date: Aug. 27, 2026

(54) DATABASE TABLE SCANNING METHODS, APPARATUSES AND DEVICES

(71) Applicant: BEIJING OCEANBASE TECHNOLOGY CO., LTD., Beijing (CN)

(72) Inventors: Zhenkun YANG, Hangzhou (CN); Quanwei WAN, Hangzhou (CN); Mingqiang ZHUANG, Hangzhou (CN)

(21) Appl. No.: 18/872,473

(22) PCT Filed: Aug. 16, 2023
(86) PCT No.: PCT/CN2023/113246

§ 371 Date: Dec. 6, 2024

(30) Foreign Application Priority Data
Oct. 11, 2022 (CN) 202211239876.2

(51) Int. Cl. G06F 16/2455; G06F 16/22

(52) U.S. Cl. CPC G06F 16/24553; G06F 16/2282

(57) ABSTRACT

Embodiments of this specification disclose database table scanning methods, apparatuses and devices. A scheme include scheme includes: determining a data column involved under a set filtering condition in the database table as a target column, where the database table has Boolean strings corresponding to the data sets respectively, and a Boolean bit in each Boolean string corresponds to a virtual row number of a data row in the corresponding data set; performing searching in the incremental data set and the baseline data set for each data row corresponding to the target column, to determine a Boolean string corresponding to a data set in which latest data of the data row is located; determining whether the latest data meet the filtering condition, and assigning a value to a corresponding Boolean bit in the Boolean string based on a determining result; determining a filtering result based on each Boolean string after the value assignment.

### TECHNICAL FIELD

This specification relates to the field of database technologies, and in particular, to database table scanning methods, apparatuses and devices.

### BACKGROUND

When data in database tables are analyzed and processed, scanning of a plurality of data columns is usually involved to obtain a filtering result. A compound filtering condition containing a plurality of single filtering conditions is used, and the single filtering conditions are combined through logical operators such as AND and OR. For example, a certain compound filtering condition is denoted as “C1<10 AND (C2>5 OR C3==8)”, where C1, C2, and C3 each denote a data column.

Currently, in operations of various combinations such as AND and OR, primary keys or physical addresses of data rows are usually used for representation and comparison, resulting in a large data volume, a large computation volume, large memory and hard disk space consumption, and large CPU consumption.

Therefore, a more efficient database table scanning scheme is needed.

### SUMMARY

One or more embodiments of this specification provide database table scanning methods, apparatuses and devices, and storage media, so as to solve the following technical problem: A more efficient database table scanning scheme is needed.

To solve the above-mentioned technical problem, one or more embodiments of this specification provide a database table scanning method. A database table is stored by a plurality of data sets, and the plurality of data sets include a baseline data set and an incremental data set. The method includes: determining a data column involved under a set a set filtering condition in the database table as a target column, where the database table has Boolean strings corresponding to the data sets respectively, and a Boolean bit in each Boolean string corresponds to a virtual row number of a data row in the corresponding data set; performing searching in the incremental data set and the baseline data set for each data row corresponding to the target column, to determine a Boolean string corresponding to a data set in which latest data of the data row is located; determining whether the latest data meet the filtering condition, and assigning a value to a corresponding Boolean bit in the Boolean string for a virtual row number of the data row in the data set based on a determining result; and determining a filtering result based on each Boolean string after the value assignment.

One or more embodiments of this specification provide a database table scanning apparatus. A database table is stored by a plurality of data sets, and the plurality of data sets include a baseline data set and an incremental data set. The apparatus includes: a target column determining module, configured to determine a data column involved under a set filtering condition in the database table as a target column, where the database table has Boolean strings corresponding to the data sets respectively, and a Boolean bit in each Boolean string corresponds to a virtual row number of a data row in the corresponding data set; a target column scanning module, configured to perform searching in the incremental data set and the baseline data set for each data row corresponding to the target column, to determine a Boolean string corresponding to a data set in which latest data of the data row is located; determine whether the latest data meet the filtering condition, and assign a value to a corresponding Boolean bit in the Boolean string for a virtual row number of the data row in the data set based on a determining result; and a filtering result determining module, configured to determine a filtering result based on each Boolean string after the value assignment.

One or more embodiments of this specification provide a database table scanning device. A database table is stored by a plurality of data sets, and the plurality of data sets includes a baseline data set and an incremental data set. The device includes at least one processor and a storage communicatively connected to the at least one processor. The storage stores instructions executable by the at least one processor, and the instructions are executed by the at least one processor, to enable the at least one processor to: determine a data column involved under a set filtering condition in the database table as a target column, where the database table has Boolean strings corresponding to the data sets respectively, and a Boolean bit in each Boolean string corresponds to a virtual row number of a data row in the corresponding data set; perform searching in the incremental data set and the baseline data set for each data row corresponding to the target column, to determine a Boolean string corresponding to a data set in which latest data of the data row is located: determine whether the latest data meet the filtering condition, and assign a value to a corresponding Boolean bit in the Boolean string for a virtual row number of the data row in the data set based on a determining result; and determine a filtering result based on each Boolean string after the value assignment.

One or more embodiments of this specification provide a non-volatile computer storage medium. A database table is stored by a plurality of data sets, and the plurality of data sets include a baseline data set and an incremental data set. The medium stores computer-executable instructions, and the computer-executable instructions are configured to: determine a data column involved under a set filtering condition in the database table as a target column, where the database table has Boolean strings corresponding to the data sets respectively, and a Boolean bit in each Boolean string corresponds to a virtual row number of a data row in the corresponding data set; perform searching in the incremental data set and the baseline data set for each data row corresponding to the target column, to determine a Boolean string corresponding to a data set in which latest data of the data row is located: determine whether the latest data meet the filtering condition, and assign a value to a corresponding Boolean bit in the Boolean string for a virtual row number of the data row in the data set based on a determining result; and determine a filtering result based on each Boolean string after the value assignment.

The above-mentioned at least one technical solution used in one or more embodiments of this specification can achieve the following beneficial effects: Based on coordination of virtual row numbers and Boolean strings, various operations related to compound filtering conditions can be efficiently performed through Boolean bit operations, and based on multi-path scanning (multi-path here can involve processing of a plurality of target columns and processing of a plurality of Boolean strings), scanning filtering efficiency is effectively improved. Moreover, this is especially suitable for a database with a storage structure including a baseline data set and an incremental data set, such as LSM-Tree, and the distribution and the scanning process of the virtual row numbers and the Boolean strings are adjusted to make the virtual row numbers and the Boolean strings involved in the scanning process lighter and scan latest data faster, which is helpful to further improve the scanning filtering efficiency.

### BRIEF DESCRIPTION OF DRAWINGS

FIG. 1 is a schematic flowchart illustrating a database table scanning method, according to one or more embodiments of this specification;

FIG. 2a and FIG. 2b are schematic diagrams illustrating a principle of a multi-layer storage structure of a database, according to one or more embodiments of this specification;

FIG. 3 is a schematic diagram illustrating a corresponding relationship between virtual row numbers and Boolean strings, according to one or more embodiments of this specification;

FIG. 4 is a schematic flowchart illustrating a data column scanning scheme, according to one or more embodiments of this specification;

FIG. 5 is a schematic flowchart illustrating a materialization scheme, according to one or more embodiments of this specification;

FIG. 6 is a schematic flowchart illustrating a structure of a database table scanning apparatus, according to one or more embodiments of this specification; and

FIG. 7 is a schematic diagram illustrating a structure of a database table scanning device according to one or more embodiments of this specification.

### DESCRIPTION OF EMBODIMENTS

Embodiments of this specification provide database table scanning methods, apparatuses and devices, and storage media.

To enable a person skilled in the art to better understand the technical solutions in this specification, the following clearly and comprehensively describes the technical solutions in the embodiments of this specification with reference to the accompanying drawings in the embodiments of this specification. Clearly, the described embodiments are merely some rather than all of the embodiments of this specification. Based on the embodiments of this specification, all other embodiments obtained by a person of ordinary skill in the art without creative efforts shall fall within the protection scope of this specification.

In view of the problems in the background, it is considered to introduce virtual row numbers and corresponding Boolean strings for scanning filtering based on a filtering condition.

In a database table, all data rows are sequentially and successively numbered by using integers starting from 0 or 1 (assumed to be 1 when described subsequently) in the order of primary keys or physical addresses, as virtual row numbers. The primary keys are a plurality of columns specified in the database table. After the primary keys are combined, there are no duplicate rows. Database data can be sequenced and aggregated based on the primary keys. The physical addresses refer to locations at which the data rows are actually stored, which are represented by, for example, ROWID. The Boolean string is represented by, for example, a data structure such as an array or a string. The Boolean string contains a plurality of Boolean bits, and each Boolean bit corresponds to one virtual row number. A value of the Boolean bit is 1 or 0 (usually 1 represents true and 0 represents false), used to indicate whether data indicated by the corresponding virtual row number meet the filtering condition. As such, AND, OR and other operations between a plurality of data columns can be efficiently performed through corresponding AND, OR and other operations of Boolean strings. Moreover, considering that this scheme has a good effect for relatively static data, but not for continuously modified data, especially for log-structured merge-tree (LSM-Tree) data. Since data rows are constantly added or deleted, which is very dynamic, virtual row numbers cannot be used directly. Therefore, the scheme is further improved to adapt to a LSM-Tree scenario. This idea is further explained in detail below.

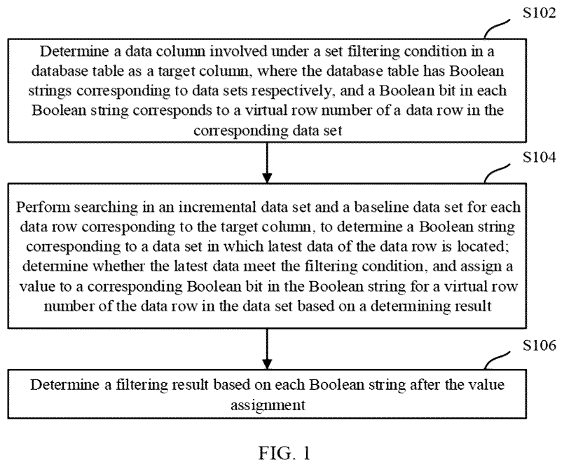

FIG. 1 is a schematic flowchart illustrating a database table scanning method, according to one or more embodiments of this specification. This procedure is executed, for example, on a database server or a service processing device connected to a database. In a scenario of FIG. 1, the database table is stored by a plurality of data sets, and the plurality of data sets include a baseline data set and an incremental data set. LSM-Tree is of such a typical structure. In the LSM-Tree, the baseline data set is usually denoted as a baseline data layer, and the incremental data set is denoted as one or more incremental data layers.

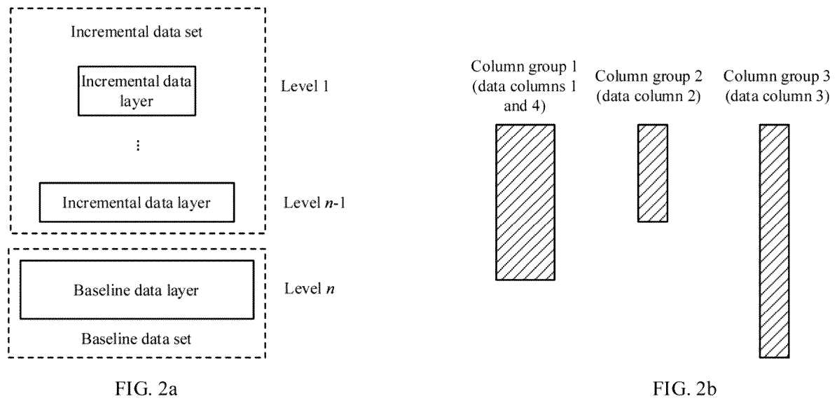

FIG. 2a and FIG. 2b are schematic diagrams illustrating a principle of a multi-layer storage structure of a database, according to one or more embodiments of this specification.

In FIG. 2a, there are a plurality of data layers, with one baseline data layer forming the above-mentioned baseline data set and one or more incremental data layers forming the above-mentioned incremental data set.

Most of data corresponding to a stable baseline time and relatively away from a current time are often stored in the baseline data layer, and data in the baseline data layer are usually in a disk. After the baseline time, newly added data (changed data caused by data insertion, data deletion and other operations) are temporarily stored in the incremental data layer. When appropriate, the data in the incremental data layer are merged into the baseline data layer, and the data in the incremental data layer are usually in a memory, while some data can be in a disk. On the whole, a time sequence corresponding to the baseline data layer is older than a time sequence corresponding to the incremental data layer. When there are a plurality of incremental data layers, there is also a time sequence relationship between them, which is shown in FIG. 2a: As the time sequence of the incremental data layer farther away from the baseline data layer is relatively newer, the incremental data layer denoted by level 1 is the latest, while the baseline data layer denoted by level n is the oldest.

In FIG. 2b, it is shown that data can be stored in data sets based on data columns or data column groups in a data set. Each data column can be stored separately, for example, column group 2 and column group 3 each contain only one data column, or a plurality of data columns can be stored together through a column group, and for example, column group 1 contains two data columns. A quantity of data rows corresponding to each data column can be differentiated.

The procedure in FIG. 1 includes the following steps:

Step S102: A data column involved under a set filtering condition in the database table is determined as a target column, where the database table has Boolean strings corresponding to the data sets respectively, and a Boolean bit in each Boolean string corresponds to a virtual row number of a data row in the corresponding data set.

In one or more embodiments of this specification, the Boolean strings corresponding to the data sets respectively can be independent of each other. The baseline data set has a corresponding Boolean string. Assuming that there are N data rows sequenced based on primary keys in the baseline data set, virtual row numbers of the data rows are sequentially 1 to N. The Boolean string corresponding to the baseline data set correspondingly has N Boolean bits each having a length of N/8 bytes. The incremental data set also has a corresponding Boolean string. Assuming that there are M data rows sequenced based on primary keys in the incremental data set (generally, M is much less than N), virtual row numbers of the data rows are 1 to M, and the Boolean string corresponding to the incremental data set correspondingly has M Boolean bits.

It is worthwhile to note that for an incremental data set containing a plurality of incremental data layers, the plurality of incremental data layers can correspond to a same Boolean string (data of the incremental data layers need to be integrated so as to be uniformly denoted by one Boolean string). The method has the advantages including that there are a small quantity of Boolean strings that need to be iterated subsequently; or each incremental data layer can have corresponding Boolean strings independent of each other (or only a plurality of incremental data layers that are not all incremental data layers correspond to a same Boolean string). The method has the advantages including ease of controlling a scale of virtual row numbers. For ease of description, some of the following embodiments are illustrated mainly with an example in which there is only one corresponding Boolean string in an entire incremental data set. For the case that a plurality of incremental data layers correspond to different Boolean strings respectively, reference can be made to subsequent processing of the incremental data set to similarly process each incremental data layer.

The filtering condition involves one or more data columns (that is, whether the filtering condition is met needs to be determined based on values in the data columns), and there is one or more single filtering conditions for each data column. If the filtering condition contains a plurality of single filtering conditions, the filtering condition is referred to as a compound filtering condition. Taking the compound filtering condition “C1<10 AND (C2>>5 OR C3 ==8)” mentioned in the background as an example, the condition involves three data columns: C1, C2, and C3. A single filtering condition of C1 is “C1<10”, and a single filtering condition of C2 is “C2>5”, while a single filtering condition of C3 is “C3==8”. The three single filtering conditions are connected by AND, OR, and parenthesis logic operators, thereby forming the compound filtering condition.

A value of a Boolean bit in a Boolean string indicates whether a corresponding data row meets a current certain single filtering condition or an entire compound filtering condition. When the value of the Boolean bit is a first value, it indicates that the condition is met, and the data row is retained after being filtered. When the value is a second value, it indicates that the condition is not met, and the data row is discarded after being filtered. The Boolean bit is a binary variable with a value of 1 or 0. For ease of description, it is assumed that the first value is 1 and the second value is 0, and vice versa.

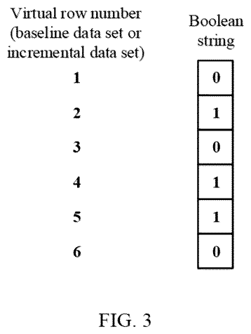

More visually, refer to FIG. 3. FIG. 3 is a schematic diagram illustrating a corresponding relationship between virtual row numbers and Boolean strings, according to one or more embodiments of this specification.

In FIG. 3, a left side is virtual row numbers in a baseline data set or an incremental data set, starting from 1, and numbered from 1 to 6 for an example. A right side is a corresponding Boolean string, which is denoted by an array, and each element of the array has 1 Boolean bit. The elements are in a one-to-one correspondence with the virtual row numbers on the left side. It is assumed that each Boolean bit has been assigned with a value. It can be seen that when values of Boolean bits corresponding to the current virtual row numbers 2, 4 and 5 are 1, it indicates that these rows meet the filtering condition, while the remaining rows do not meet the filtering condition. The Boolean string has a small data volume and a small storage burden, and a cost reduction effect can be further improved by compressing the Boolean string.

In one or more embodiments of this specification, there can be a plurality of target columns. In this case, the target columns can be scanned in parallel to improve efficiency.

Step S104: Searching is performed in the incremental data set and the baseline data set for each data row corresponding to the target column, to determine a Boolean string corresponding to a data set in which latest data of the data row is located; whether the latest data meet the filtering condition is determined, and a value is assigned to a corresponding Boolean bit in the Boolean string for a virtual row number of the data row in the data set based on a determining result.

Step S104 shows the target column scanning process. The process includes sub-steps of determining whether the filtering condition is met and assigning values to Boolean bits. It is worthwhile to note that when there are a plurality of single filtering conditions, the two steps can be performed in cross-cooperation. Specifically, when whether the latest data meet the filtering condition is determined, it can be first determined whether some data in the latest data (for example, row data belonging to a certain target column) meet a certain corresponding single filtering condition, and then the values are correspondingly assigned to the Boolean bits. However, the assigned values in this case may not necessarily be a final result, and it is further needed to continue the determining and value assignment for other target columns and other single filtering conditions based on the assigned value. Finally, final assigned values of related Boolean bits for the entire compound filtering condition are obtained to obtain a subsequent filtering result.

In one or more embodiments of this specification, when data are filtered, latest data of a data row should be taken as the standard. Latest data of a certain data row may be in the baseline data set (for example, the data row has not been updated recently) or in the incremental data set (for example, the data row has been updated recently).

The latest data specifically refer latest data of the corresponding data row on the current target column. Latest data of a same data row on a certain specified data column is in one of the data sets. To improve search efficiency, for a certain data row corresponding to a certain target column, during scanning, searching for the latest data in the incremental data set can be performed as a priority based on a time sequence from new to old. If the latest data are found, there is no need to continue searching in the baseline data set. If the latest data are not found, then searching in the baseline data set continues.

It is determine whether the filtering condition is met based on the latest data, and values are correspondingly assigned to the Boolean bits in the corresponding Boolean string of the data set in which the latest data are located, so that the values of the Boolean bits can timely, correctly and orderly show a relationship between the corresponding data and the filtering condition at low redundancy, thereby helping to efficiently obtain the filtering result in the future.

In one or more embodiments of this specification, a first value is assigned to the corresponding Boolean bit in the Boolean string for the virtual row number of the data row in the data set if the determining result is yes, to indicate retention after filtering, or a second value is assigned to the corresponding Boolean bit in the Boolean string for the virtual row number of the data row in the data set if the determining result is no, to indicate discarding after the filtering.

In a case that the filtering condition is a single filtering condition, the processing procedure in the previous paragraph is concise and easy to understand. In a case that the filtering condition is a compound filtering condition involving a plurality of data columns (that is, a plurality of target columns) of the database table, Boolean bit operations are specifically further involved in the processing. Specifically, assigned values of a same Boolean bit respectively corresponding to a plurality of single filtering conditions included in the compound filtering condition are determined; a Boolean bit operation is correspondingly performed between the corresponding assigned values based on a compound operation of the plurality of single filtering conditions in the compound filtering condition; and it is determined whether the latest data meet the compound filtering condition based on a result of the Boolean bit operation.

For example, for a first target column, it is determined whether a corresponding single filtering condition is met and values are correspondingly assigned, and then an obtained Boolean string is given to a next target column, so as to perform a Boolean operation with the assigned values corresponding to the next target column. For example, for an AND operator, a data row with a Boolean bit value of 0 can be directly skipped, while for an OR operator, each corresponding data row needs to be determined to obtain assigned values, which then undergo a bitwise OR operation with a previous Boolean string. Certainly, implementations are not limited to this one, but are multiple. For example, for a Boolean string, alternatively, a Boolean string copy can be generated for each target column, then values are assigned to the Boolean string copies based on the corresponding target columns, and then a Boolean bit operation is performed between the Boolean string copies to obtain a Boolean string determined by final assigned values.

Step S106: A filtering result is determined based on each Boolean string after the value assignment.

In one or more embodiment of this specification, the filtering result is determine based on Boolean bits assigned with the first value in the Boolean string. Regardless of the data order, a data row corresponding to a Boolean bit with the first value in each Boolean string after the value alignment can be determined as a retained data row, and the filtering result can be determined based on to each retained data row. If related redundant data and unexpected data are eliminated completely, it can be considered to directly determine each retained data row as the filtering result.

To improve user experience and output filtering results efficiently and orderly, a scheme for determining filtering results is further provided, specifically including: determining a virtual row number corresponding to the first Boolean bit with the first value in the Boolean string corresponding to the baseline data set as a first row number; determining a virtual row number corresponding to the first Boolean bit with the first value in the Boolean string corresponding to the incremental data set as a second row number; determining a first data row identifier corresponding to the first row number and a second data row identifier corresponding to the second row number, where both the first data row identifier and the second data row identifier are primary keys, physical addresses, or other identifiers that can uniquely identify a data row; comparing a size of the first data row identifier with a size of the second data row identifier, and taking the data row corresponding to the data row identifier with a smaller size as a retained data row; determining a virtual row number corresponding to a next Boolean bit with the first value corresponding to the data row identifier with a smaller size, to continue the above-mentioned process of comparing and taking a data row until processing of the Boolean strings corresponding to the baseline data set and the incremental data set is completed; and determining each retained data row as the filtering result. The filtering results obtained in this way conform to the order of primary keys or physical addresses. This processing method is particularly efficient in a case that the data volume of the filtering results is large, and part of the order that virtual row numbers can represent is fully used, thereby effectively reducing redundant sequencing actions and further avoiding centralized sequencing of a large number of primary keys or physical addresses. More visual supplementary explanation is provided below with reference to an actual scenario.

In one or more embodiments of this specification, the redundant data and the unexpected data are mentioned above. The redundant data include, for example, old data corresponding to the latest data and Boolean bits corresponding to the old data. The unexpected data include deleted data and Boolean bits corresponding to the deleted data. For the data, the corresponding Boolean bits can be actively assigned with the second value to prevent the Boolean bits from still having values assigned at a previous time, which otherwise cannot correctly reflect a latest situation.

For example, after the searching in the incremental data set and the baseline data set, it is determined whether the above-mentioned found latest data exist in the incremental data set or the baseline data set. If the latest data exist in the incremental data set and the data of the data row also exist in the baseline data set (which indicates that the data in the baseline data set are old data), the Boolean string corresponding to the baseline data set is determined. and a second value is assigned to a corresponding Boolean bit in the Boolean string for a virtual row number of the data row in the baseline data set, to indicate discarding after filtering.

For another example, after the determining a Boolean string corresponding to a data set in which latest data of the data row is located, it is determined whether the latest data of the data row include a deletion mark, and an operation of the deletion mark on the data row at a current time is a data deletion operation. If yes, the second value is assigned to the corresponding Boolean bit in the Boolean string for the virtual row number of the data row in the data set, to indicate discarding after the filtering.

By the method of FIG. 1, based on coordination of virtual row numbers and Boolean strings, various operations related to compound filtering conditions can be efficiently performed through Boolean bit operations, and based on multi-path scanning, scanning filtering efficiency is effectively improved. Moreover, this is especially suitable for a database with a storage structure including a baseline data set and one or more incremental data sets, such as LSM-Tree, and the distribution and the scanning process of the virtual row numbers and the Boolean strings are adjusted to make the virtual row numbers and the Boolean strings involved in the scanning process lighter and scan latest data faster, which is helpful to further improve the scanning filtering efficiency.

Based on the method shown in FIG. 1, this specification further provides some specific implementation solutions and extension solutions of the method, which are further explained below.

In one or more embodiments of this specification, as mentioned earlier, in the LSM-Tree scenario, since data rows are constantly added or deleted, which is very dynamic, virtual row numbers cannot be used directly. To solve this problem, snapshot reading is used for data reading in the database in which the above-mentioned database table is located, which can introduce virtual row numbers similar to read-only data. During the reading process, even if latest incremental data being modified in a memory remains unchanged for the snapshot used, and therefore it can be believed that all incremental and baseline data are unchanged. In this case, the above-mentioned data rows that can be obtained are also snapshot data, thereby facilitating use of virtual row numbers and efficient execution of a data filtering operation involving a plurality of data columns.

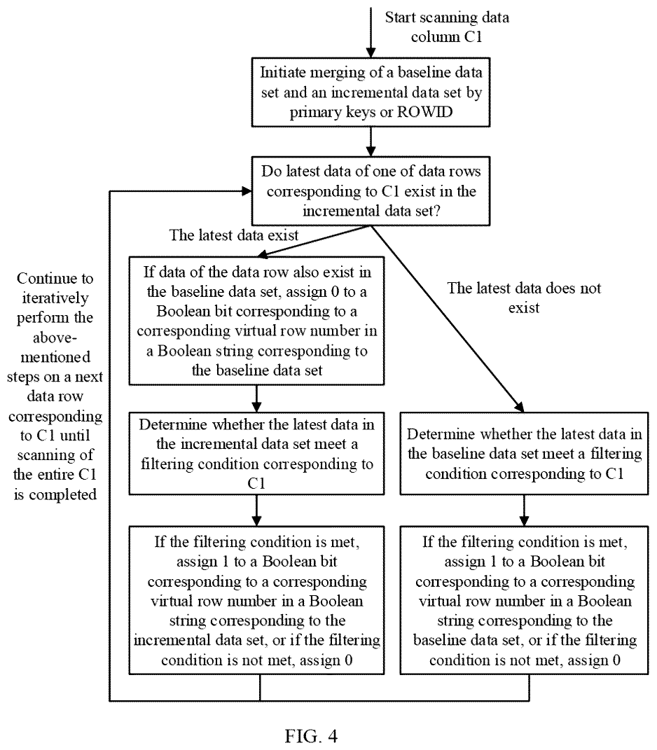

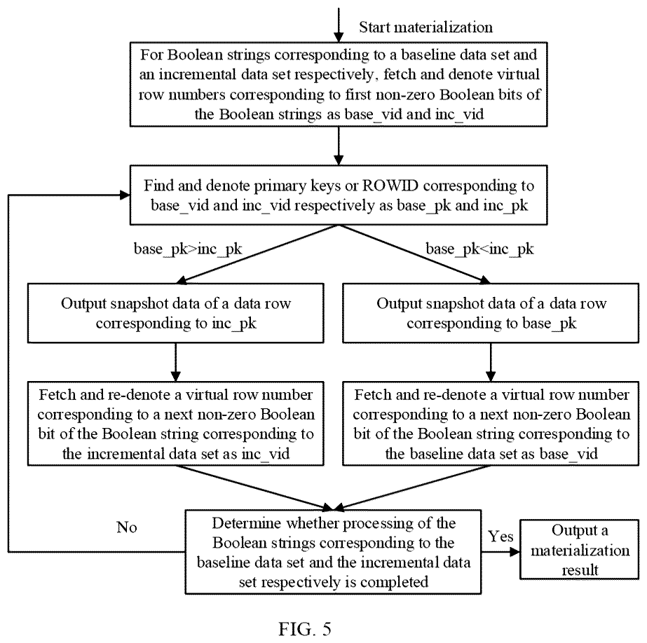

The previous explanation of this solution is provided. For ease of understanding, example implementation solutions of two important parts above are demonstrated with reference to specific scenarios and more complete examples, as shown in FIG. 4 and FIG. 5.

FIG. 4 is a schematic flowchart illustrating a data column scanning scheme, according to one or more embodiments of this specification.

In FIG. 4, a scanning process of data column C1 is shown. The process can include the following steps: starting scanning data column C1, initiating merging of a baseline data set and an incremental data set by primary keys or ROWID, and determining whether latest data of a certain data row corresponding to C1 exist in the incremental data set through this process; if the latest data exist, indicating that the latest data of the data row are in the incremental data set, and further determining whether the data of the data row also exist in the baseline data set; if the data also exist in the baseline data set, assigning 0 to a Boolean bit corresponding to a corresponding virtual row number in a Boolean string corresponding to the baseline data set, and further determining whether the latest data in the incremental data set meet a filtering condition corresponding to C1 (for example, C1>5); if the filtering condition is met, assigning 1 to a Boolean bit corresponding to a corresponding virtual row number in a Boolean string corresponding to the incremental data set, or if the filtering condition is not met, assigning 0; if the latest data do not exist, indicating the latest data of the data row are in the baseline data set, and determining whether the latest data in the baseline data set meet the filtering condition corresponding to C1; if the filtering condition is met, assigning 1 to the Boolean bit corresponding to the corresponding virtual row number in the Boolean string corresponding to the baseline data set, or if the filtering condition is not met, assigning 0; and continuing to iteratively perform the above-mentioned steps on a next data row corresponding to C1 until scanning of the entire C1 is completed.

FIG. 5 is a schematic flowchart illustrating a materialization scheme, according to one or more embodiments of this specification. The materialization here refers to obtaining data from a data table that meet the filtering condition.

Based on the procedure in FIG. 4, after scanning of data columns that need to be scanned is completed, Boolean strings corresponding to the baseline data set and the incremental data set respectively are obtained. When materialization is needed (for example, when filtering results are returned to a user), the Boolean strings can be merged with primary keys or ROWID as keys. Specifically, the procedure shown in FIG. 5 can include the following steps: starting materialization, fetching and denoting virtual row numbers corresponding to first non-zero Boolean bits of Boolean strings corresponding to the baseline data set and incremental data set respectively as base_vid and ine_vid; and finding and denoting primary keys or ROWID corresponding to base_vid and inc_vid respectively as base_pk and inc_pk;

if base_pk>inc_pk, outputting snapshot data of a data row corresponding to ine_pk, in addition, the current inc_vid being consumed, and fetching and denoting a virtual row mumber corresponding to a next non-zero Boolean bit of the Boolean string corresponding to the incremental data set as inc_vid; if base pk<inc_pk, outputting snapshot data of a data row corresponding to base_pk, in addition, the current base_vid being consumed, and fetching and re-denoting a virtual row number corresponding to a next non-zero Boolean bit of the Boolean string corresponding to the baseline data set as base_vid; iteratively performing the steps of comparing and fetching data, and determining whether processing of Boolean strings corresponding to the baseline data set and the incremental data set respectively is completed; if not, continuing the iteration, or if yes, performing the next step; taking the fetched snapshot data as a materialization result (that is, a filtering result), and outputting the materialization result and returning the result to a user with a need.

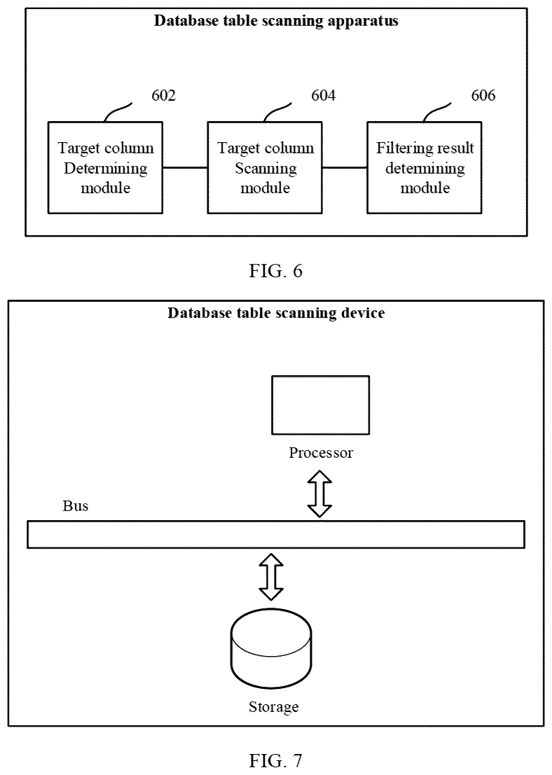

Based on the same idea, one or more embodiments of this specification further provide an apparatus and a device corresponding to the above-mentioned method, as shown in FIG. 6 and FIG. 7.

FIG. 6 is a schematic flowchart illustrating a structure of a database table scanning apparatus, according to one or more embodiments of this specification. A database table is stored by a plurality of data sets, and the plurality of data sets include a baseline data set and an incremental data set. The apparatus includes: a target column determining module 602, configured to determine a data column involved under a set filtering condition in the database table as a target column, where the database table has Boolean strings corresponding to the data sets respectively, and a Boolean bit in each Boolean string corresponds to a virtual row number of a data row in the corresponding data set; a target column scanning module 604, configured to perform searching in the incremental data set and the baseline data set for each data row corresponding to the target column, to determine a Boolean string corresponding to a data set in which latest data of the data row is located; determine whether the latest data meet the filtering condition, and assign a value to a corresponding Boolean bit in the Boolean string for a virtual row number of the data row in the data set based on a determining result; and a filtering result determining module 606, configured to determine a filtering result based on each Boolean string after the value assignment.

Optionally, the target column scanning module 604 is configured to assign a first value to the corresponding Boolean bit in the Boolean string for the virtual row number of the data row in the data set if the determining result is yes, to indicate retention after filtering, or assign a second value to the corresponding Boolean bit in the Boolean string for the virtual row number of the data row in the data set if the determining result is no, to indicate discarding after the filtering.

Optionally, the target column scanning module 604 is configured to determine, after the searching in the incremental data set and the baseline data set, whether the latest data exist in the incremental data set or the baseline data set; and determine, if the latest data exist in the incremental data set and the data of the data row also exist in the baseline data set, the Boolean string corresponding to the baseline data set, and assign a second value to a corresponding Boolean bit in the Boolean string for a virtual row number of the data row in the baseline data set, to indicate discarding after filtering.

Optionally, the filtering condition is a compound filtering condition involving a plurality of data columns of the database table; and the target column scanning module 604 is configured to determine assigned values of a same Boolean bit respectively corresponding to a plurality of single filtering conditions included in the compound filtering condition; correspondingly perform a Boolean bit operation between the corresponding assigned values based on a compound operation of the plurality of single filtering conditions in the compound filtering condition; and determine whether the latest data meet the compound filtering condition based on a result of the Boolean bit operation.

Optionally, the target column scanning module 604 is configured to determine, after the determining a Boolean string corresponding to a data set in which latest data of the data row is located, whether the latest data of the data row include a deletion mark; and assign the second value to the corresponding Boolean bit in the Boolean string for the virtual row number of the data row in the data set if yes, to indicate discarding after the filtering.

Optionally, the filtering result determining module 606 is configured to determine a data row corresponding to the Boolean bit with the first value in each Boolean string after the value assignment as a retained data row; and determine the filtering result based on each retained data row.

Optionally, the filtering result determining module 606 is configured to determine a virtual row number corresponding to the first Boolean bit with the first value in the Boolean string corresponding to the baseline data set as a first row number; determine a virtual row number corresponding to the first Boolean bit with the first value in the Boolean string corresponding to the incremental data set as a second row number; determine a first data row identifier corresponding to the first row number and a second data row identifier corresponding to the second row number, where both the first data row identifier and the second data row identifier are primary keys or physical addresses; compare a size of the first data row identifier with a size of the second data row identifier, and take the data row corresponding to the data row identifier with a smaller size as a retained data row; determine a virtual row number corresponding to a next Boolean bit with the first value corresponding to the data row identifier with a smaller size, to continue the above-mentioned process of comparing and taking a data row until processing of the Boolean strings corresponding to the baseline data set and the incremental data set is completed; and determine each retained data row as the filtering result.

Optionally, the data row is snapshot data.

FIG. 7 is a schematic diagram illustrating a structure of a database table scanning device according to one or more embodiments of this specification. A database table is stored by a plurality of data sets, and the plurality of data sets include a baseline data set and an incremental data set. The device includes: at least one processor; and a storage communicatively connected to the at least one processor, where the storage stores instructions executable by the at least one processor, and the instructions are executed by the at least one processor, to enable the at least one processor to: determine a data column involved under a set filtering condition in the database table as a target column, where the database table has Boolean strings corresponding to the data sets respectively, and a Boolean bit in each Boolean string corresponds to a virtual row number of a data row in the corresponding data set; perform searching in the incremental data set and the baseline data set for each data row corresponding to the target column, to determine a Boolean string corresponding to a data set in which latest data of the data row is located; determine whether the latest data meet the filtering condition, and assign a value to a corresponding Boolean bit in the Boolean string for a virtual row number of the data row in the data set based on a determining result; and determine a filtering result based on each Boolean string after the value assignment.

Based on the same idea, one or more embodiments of this specification further provide a non-volatile computer storage medium corresponding to the method in FIG. 1. A database table is stored by a plurality of data sets, and the plurality of data sets include a baseline data set and an incremental data set. The medium stores computer-executable instructions, and the computer-executable instructions are configured to: determine a data column involved under a set filtering condition in the database table as a target column, where the database table has Boolean strings corresponding to the data sets respectively, and a Boolean bit in each Boolean string corresponds to a virtual row number of a data row in the corresponding data set; perform searching in the incremental data set and the baseline data set for each data row corresponding to the target column, to determine a Boolean string corresponding to a data set in which latest data of the data row is located; determine whether the latest data meet the filtering condition, and assign a value to a corresponding Boolean bit in the Boolean string for a virtual row number of the data row in the data set based on a determining result; and determine a filtering result based on each Boolean string after the value assignment.

In the 1990s, improvements to a technology could clearly be distinguished as improvements in hardware (for example, improvements to circuit structures such as diodes, transistors, and switches) or software (improvements to method procedures). However, as technologies develop, current improvements to many method procedures can be considered as direct improvements to hardware circuit structures. Almost all designers program an improved method procedure into a hardware circuit, to obtain a corresponding hardware circuit structure. Therefore, a method procedure can be improved by a hardware entity module. For example, a programmable logic device (PLD) (for example, a field programmable gate array (FPGA) is such an integrated circuit, and a logical function of the PLD is determined by a user through device programming. The designer performs programming to “integrate” a digital system to a PLD without requesting a chip manufacturer to design and manufacture an application-specific integrated circuit chip. In addition, currently, instead of manually manufacturing an integrated circuit chip, such programming is mostly implemented by using “logic compiler” software. The “logic compiler” software is similar to a software compiler used to develop and write a program. Original code needs to be written in a specific programming language before being compiled. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). At present, the Very-High-Speed Integrated Circuit Hardware Description Language (VHDL) and Verilog are most commonly used. It should also be clear to a person skilled in the art that a hardware circuit that implements a logical method procedure can be readily obtained once the method procedure is logically programmed by using the above-mentioned several hardware description languages and is programmed into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The storage controller can alternatively be implemented as a part of control logic of the storage. A person skilled in the art also knows that, in addition to implementing the controller by using only computer-readable program code, logic programming can be performed on a method step, so the controller implements a same function in a form of a logie gate, a switch, an application-specific integrated circuit, a programmable logic controller, an embedded microcontroller, etc. Therefore, the controller can be considered as a hardware component, and an apparatus included in the controller and configured to implement various functions can also be considered as a structure in the hardware component. Or the apparatus configured to implement various functions can even be considered as both a software module implementing the method and a structure in the hardware component.

The system, apparatus, module, or unit illustrated in the above-mentioned embodiments can be specifically implemented by using a computer chip or an entity, or can be implemented by using a product having a certain function. A typical implementation device is a computer. Specifically, for example, the computer can be a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, when this specification is implemented, functions of the units can be implemented in one or more pieces of software and/or hardware.

A person skilled in the art should understand that the embodiments of this specification can be provided as methods, systems, or computer program products. Therefore, the embodiments of this specification can use a form of hardware only embodiments, software only embodiments, or embodiments with a combination of software and hardware. In addition, the embodiments of this specification can use a form of a computer program product that is implemented on one or more computer-usable storage media (including but not limited to a disk storage, a CD-ROM, an optical storage, or the like) that include computer-usable program code.

This specification is described with reference to flowcharts and/or block diagrams of a method, a device (system), and a computer program product according to embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specified function in one or more procedures in the flowcharts and/or in one or more blocks in the block diagrams.

These computer program instructions can alternatively be stored in a computer-readable memory that can instruct a computer or another programmable data processing device to work in a specific way, so that an instruction stored in the computer-readable memory generates an artifact including an instruction apparatus, and the instruction apparatus implements a specified function in one or more procedures in the flowcharts and/or one or more blocks in the block diagrams.

Alternatively, these computer program instructions can be loaded onto a computer or another programmable data processing device, so that a series of operations and steps are performed on the computer or the another programmable device, to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), an input/output interface, a network interface, and a memory.

The memory may include a form such as a non-permanent memory, a random access memory (RAM), and/or a non-volatile memory in a computer-readable medium, for example, a read-only memory (ROM) or a flash memory (flash RAM). The memory is an example of the computer-readable medium.

Computer-readable media, including permanent and non-permanent, removable and non-removable media, can implement information storage by any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be configured to store information that can be accessed by a computing device. Based on the definition in this specification, the computer-readable medium does not include transitory computer-readable media (transitory media) such as a modulated data signal and carrier.

It is worthwhile to further note that the terms “include”, “comprise”, or any other variants thereof are intended to cover a non-exclusive inclusion, so that a process, method, product, or device that includes a list of elements not only includes those elements but also includes other elements which are not expressly listed, or further includes elements inherent to such a process, method, product, or device. Without more constraints, an element preceded by “includes a . . . ” does not preclude the existence of additional identical elements in the process, method, product or device that includes the element.

This specification can be described in the general context of computer-executable instructions, for example, a program module. Generally, the program module includes a routine, a program, an object, a component, a data structure, etc. for executing a specific task or implementing a specific abstract data type. This specification can alternatively be practiced in distributed computing environments in which tasks are performed by remote processing devices that are connected through a communication network. In the distributed computing environment, a program module can be located in local and remote computer storage media including a storage device.

The embodiments of this specification are described in a progressive way. For same or similar parts in the embodiments, mutual reference can be made to the embodiments. Each embodiment focuses on a difference from other embodiments. In particular, the apparatus embodiments, the device embodiments, and the non-volatile computer storage medium embodiments are basically similar to the method embodiments, and therefore are described briefly. For related parts, reference can be made to some descriptions of the method embodiments.

Specific embodiments of this specification are described above. Other embodiments fall within the scope of the appended claims. In some cases, actions or steps described in the claims can be performed in an order different from those in the embodiments and desired results can still be achieved. In addition, processes described in the accompanying drawings do not necessarily require a specific order or a sequential order shown to achieve the desired results. In some implementations, multitasking and parallel processing are also feasible or may be advantageous.

The above-mentioned descriptions are merely one or more embodiments of this specification, and are not intended to limit this specification. For a person skilled in the art, one or more embodiments of this specification can have various changes and variations. Any modification, equivalent replacement, improvement, etc. made within the spirit and principle of one or more embodiments of this specification shall fall within the scope of the claims of this specification.

1. A database table scanning method, wherein a database table is stored by a plurality of data sets, the plurality of data sets comprise a baseline data set and an incremental data set, and the method comprises:
determining a data column involved under a set filtering condition in the database table as a target column, wherein the database table has Boolean strings corresponding to the data sets respectively, and a Boolean bit in each Boolean string corresponds to a virtual row number of a data row in the corresponding data set;
performing searching in the incremental data set and the baseline data set for each data row corresponding to the target column, to determine a Boolean string corresponding to a data set in which latest data of the data row is located; determining whether the latest data meet the filtering condition, and assigning a value to a corresponding Boolean bit in the Boolean string for a virtual row number of the data row in the data set based on a determining result; and
determining a filtering result based on each Boolean string after the value assignment.

2. The method according to claim 1, wherein assigning a value to the corresponding Boolean bit in the Boolean string for the virtual row number of the data row in the data set based on a determining result specifically comprises:
assigning a first value to the corresponding Boolean bit in the Boolean string for the virtual row number of the data row in the data set upon determining that the determining result is that the latest data meet the filtering condition, to indicate retention after filtering, or
assigning a second value to the corresponding Boolean bit in the Boolean string for the virtual row number of the data row in the data set upon determining that the determining result is that the latest data do not meet the filtering condition, to indicate discarding after the filtering.

3. The method according to claim 1, wherein after searching in the incremental data set and the baseline data set, the method further comprises:
determining whether the latest data exist in the incremental data set or the baseline data set; and
determining, upon determining that the latest data exist in the incremental data set and the data of the data row also exist in the baseline data set, the Boolean string corresponding to the baseline data set, and assigning a second value to a corresponding Boolean bit in the Boolean string for a virtual row number of the data row in the baseline data set, to indicate discarding after filtering.

4. The method according to claim 1, wherein the filtering condition is a compound filtering condition involving a plurality of data columns of the database table; and
determining whether the latest data meet the filtering condition specifically comprises:
determining assigned values of a same Boolean bit respectively corresponding to a plurality of single filtering conditions comprised in the compound filtering condition;
correspondingly performing a Boolean bit operation between the corresponding assigned values based on a compound operation of the plurality of single filtering conditions in the compound filtering condition; and
determining whether the latest data meet the compound filtering condition based on a result of the Boolean bit operation.

5. The method according to claim 1, wherein after determining the Boolean string corresponding to the data set in which latest data of the data row is located, the method further comprises:
determining whether the latest data of the data row comprise a deletion mark; and
assigning the second value to the corresponding Boolean bit in the Boolean string for the virtual row number of the data row in the data set upon determining that the latest data of the data row comprise a deletion mark, to indicate discarding after the filtering.

6. The method according to claim 2, wherein determining the filtering result based on each Boolean string after the value assignment specifically comprises:
determining a data row corresponding to the Boolean bit with the first value in each Boolean string after the value assignment as a retained data row; and
determining the filtering result based on each retained data row.

7. The method according to claim 2, wherein determining the filtering result specifically comprises:
determining a virtual row number corresponding to the first Boolean bit with the first value in the Boolean string corresponding to the baseline data set as a first row number;
determining a virtual row number corresponding to the first Boolean bit with the first value in the Boolean string corresponding to the incremental data set as a second row number;
determining a first data row identifier corresponding to the first row number and a second data row identifier corresponding to the second row number, wherein both the first data row identifier and the second data row identifier are primary keys or physical addresses;
comparing a size of the first data row identifier with a size of the second data row identifier, and taking the data row corresponding to the data row identifier with a smaller size as a retained data row;
determining a virtual row number corresponding to a next Boolean bit with the first value corresponding to the data row identifier with a smaller size, to continue the above-mentioned process of comparing and taking a data row until processing of the Boolean strings corresponding to the baseline data set and the incremental data set is completed; and
determining each retained data row as the filtering result.

8. The method according to claim 1, wherein the data row is snapshot data.

9-16. (canceled)

17. A database table scanning device, wherein a database table is stored by a plurality of data sets, the plurality of data sets comprise a baseline data set and an incremental data set, and the device comprises:
at least one processor; and
a storage communicatively connected to the at least one processor, wherein
the storage stores instructions executable by the at least one processor, and the instructions are executed by the at least one processor, to enable the at least one processor to:
determine a data column involved under a set filtering condition in the database table as a target column, wherein the database table has Boolean strings corresponding to the data sets respectively, and a Boolean bit in each Boolean string corresponds to a virtual row number of a data row in the corresponding data set;
perform searching in the incremental data set and the baseline data set for each data row corresponding to the target column, to determine a Boolean string corresponding to a data set in which latest data of the data row is located; determine whether the latest data meet the filtering condition, and assign a value to a corresponding Boolean bit in the Boolean string for a virtual row number of the data row in the data set based on a determining result; and
determine a filtering result based on each Boolean string after the value assignment.

18. The database table scanning device according to claim 17, wherein the database table scanning device being caused to assign a value to the corresponding Boolean bit in the Boolean string for the virtual row number of the data row in the data set based on a determining result specifically includes being caused to:
assign a first value to the corresponding Boolean bit in the Boolean string for the virtual row number of the data row in the data set upon determining that the determining result is that the latest data meet the filtering condition, to indicate retention after filtering, or assign a second value to the corresponding Boolean bit in the Boolean string for the virtual row number of the data row in the data set upon determining that the determining result is that the latest data do not meet the filtering condition, to indicate discarding after the filtering.

19. The database table scanning device according to claim 17, wherein after searching in the incremental data set and the baseline data set, the database table scanning device is further caused to:
determine whether the latest data exist in the incremental data set or the baseline data set; and
determine, upon determining that the latest data exist in the incremental data set and the data of the data row also exist in the baseline data set, the Boolean string corresponding to the baseline data set, and assign a second value to a corresponding Boolean bit in the Boolean string for a virtual row number of the data row in the baseline data set, to indicate discarding after filtering.

20. The database table scanning device according to claim 17, wherein the filtering condition is a compound filtering condition involving a plurality of data columns of the database table; and
the database table scanning device being caused to determine whether the latest data meet the filtering condition specifically includes being caused to:
determine assigned values of a same Boolean bit respectively corresponding to a plurality of single filtering conditions comprised in the compound filtering condition;
correspondingly perform a Boolean bit operation between the corresponding assigned values based on a compound operation of the plurality of single filtering conditions in the compound filtering condition; and
determine whether the latest data meet the compound filtering condition based on a result of the Boolean bit operation.

21. The database table scanning device according to claim 17, wherein after determining the Boolean string corresponding to the data set in which latest data of the data row is located, the database table scanning device is further caused to:
determine whether the latest data of the data row comprise a deletion mark; and
assign the second value to the corresponding Boolean bit in the Boolean string for the virtual row number of the data row in the data set upon determining that the latest data of the data row comprise a deletion mark, to indicate discarding after the filtering.

22. The database table scanning device according to claim 18, wherein the database table scanning device being caused to determine the filtering result based on each Boolean string after the value assignment specifically includes being caused to:
determine a data row corresponding to the Boolean bit with the first value in each Boolean string after the value assignment as a retained data row; and
determine the filtering result based on each retained data row.

23. The database table scanning device according to claim 18, wherein the database table scanning device being caused to determine the filtering result specifically includes being caused to:
determine a virtual row number corresponding to the first Boolean bit with the first value in the Boolean string corresponding to the baseline data set as a first row number;
determine a virtual row number corresponding to the first Boolean bit with the first value in the Boolean string corresponding to the incremental data set as a second row number;
determine a first data row identifier corresponding to the first row number and a second data row identifier corresponding to the second row number, wherein both the first data row identifier and the second data row identifier are primary keys or physical addresses;
compare a size of the first data row identifier with a size of the second data row identifier, and take the data row corresponding to the data row identifier with a smaller size as a retained data row;
determine a virtual row number corresponding to a next Boolean bit with the first value corresponding to the data row identifier with a smaller size, to continue the above-mentioned process of comparing and taking a data row until processing of the Boolean strings corresponding to the baseline data set and the incremental data set is completed; and
determine each retained data row as the filtering result.

24. The database table scanning device according to claim 17, wherein the data row is snapshot data.

25. A non-transitory computer-readable storage medium, wherein a database table is stored by a plurality of data sets, the plurality of data sets comprise a baseline data set and an incremental data set, the computer-readable storage medium stores computer instructions, and when the instructions are executed by a processor, the processor is caused to:
determine a data column involved under a set filtering condition in the database table as a target column, wherein the database table has Boolean strings corresponding to the data sets respectively, and a Boolean bit in each Boolean string corresponds to a virtual row number of a data row in the corresponding data set;
perform searching in the incremental data set and the baseline data set for each data row corresponding to the target column, to determine a Boolean string corresponding to a data set in which latest data of the data row is located; determine whether the latest data meet the filtering condition, and assign a value to a corresponding Boolean bit in the Boolean string for a virtual row number of the data row in the data set based on a determining result; and
determine a filtering result based on each Boolean string after the value assignment.

26. The non-transitory computer-readable storage medium according to claim 25, wherein the processor being caused to assign a value to the corresponding Boolean bit in the Boolean string for the virtual row number of the data row in the data set based on a determining result specifically includes being caused to:
assign a first value to the corresponding Boolean bit in the Boolean string for the virtual row number of the data row in the data set upon determining that the determining result is that the latest data meet the filtering condition, to indicate retention after filtering, or
assign a second value to the corresponding Boolean bit in the Boolean string for the virtual row number of the data row in the data set upon determining that the determining result is that the latest data do not meet the filtering condition, to indicate discarding after the filtering.

27. The non-transitory computer-readable storage medium according to claim 25, wherein after searching in the incremental data set and the baseline data set, the processor is further caused to:
determine whether the latest data exist in the incremental data set or the baseline data set; and
determine, upon determining that the latest data exist in the incremental data set and the data of the data row also exist in the baseline data set, the Boolean string corresponding to the baseline data set, and assign a second value to a corresponding Boolean bit in the Boolean string for a virtual row number of the data row in the baseline data set, to indicate discarding after filtering.

28. The non-transitory computer-readable storage medium according to claim 25, wherein the filtering condition is a compound filtering condition involving a plurality of data columns of the database table; and
the processor being caused to determine whether the latest data meet the filtering condition specifically includes being caused to:
determine assigned values of a same Boolean bit respectively corresponding to a plurality of single filtering conditions comprised in the compound filtering condition;
correspondingly perform a Boolean bit operation between the corresponding assigned values based on a compound operation of the plurality of single filtering conditions in the compound filtering condition; and
determine whether the latest data meet the compound filtering condition based on a result of the Boolean bit operation.
